(19) United States
(12) Patent Application Publication
(10) Pub. No.: US 2026/0002799 A1
(43) Pub. Date: Jan. 1, 2026

(54) MAGNET-BASED ROTATIONAL ANGLE SENSOR SYSTEM

(71) Applicant: FRABA B.V., SG HEERLEN (NL)

(72) Inventors: SONJA HUSMANN, WUERSELEN (DE); HANNO VOLKER, AACHEN (DE)

(73) Assignee: FRABA B.V., SG HEERLEN (NL)

(21) Appl. No.: 18/881,312

(22) PCT Filed: Jul. 7, 2022
(86) PCT No.: PCT/EP2022/068890

§ 371 Date: Jan. 6, 2025

(51) Int. Cl. G01D 5/245

(52) U.S. Cl. CPC G01D 5/2454; G01D 2205/26

(57) ABSTRACT

A magnet-based angle-of-rotation sensor system for detecting a shaft's rotational movement includes an excitation unit having a magnet, a Wiegand sensor unit having a Wiegand wire arranged within a sensor coil, a sensor unit, and an evaluation electronics. The excitation unit rotates with the shaft and generates an alternating excitation magnetic field at the Wiegand sensor unit and at the sensor unit. The Wiegand sensor unit generates Wiegand sensor voltage pulses in the sensor coil via magnetic field. The sensor unit detects the magnetic field and provides a sensor signal. The evaluation electronics detects the Wiegand sensor voltage pulses and determines a number of revolutions based thereon, and receives the sensor signal and determines an angle of rotation value based thereon. The evaluation electronics alternately applies a first and a second compensation parameter to the received magnetic field sensor signal when determining the angle of rotation value.

### CROSS REFERENCE TO PRIOR APPLICATIONS

This application is a U.S. National Phase application under 35 U.S.C. § 371 of International Application No. PCT/EP2022/068890, filed on Jul. 7, 2022. The International Application was published in German on Jan. 11, 2024 as WO 2024/008292 A1 under PCT Article 21(2).

### FIELD

The present invention relates to a magnet-based angle-of-rotation sensor system for detecting a rotational movement of a shaft, comprising: an excitation unit with at least one excitation magnet, a Wiegand sensor unit with a sensor coil and at least one Wiegand wire which is arranged within the sensor coil, a magnetic field sensor unit, and an evaluation electronics, wherein: the excitation unit is configured to be mounted so as to rotate with the shaft and to generate an alternating excitation magnetic field at the location of the Wiegand sensor unit and at the location of the magnetic field sensor unit when the shaft rotates, the Wiegand sensor unit is configured so that Wiegand sensor voltage pulses are generated in the sensor coil by the alternating excitation magnetic field, the magnetic field sensor unit is configured to detect the alternating excitation magnetic field and to provide a corresponding magnetic field sensor signal, and the evaluation electronics is configured to detect the Wiegand sensor voltage pulses and to determine a number of revolutions based thereon as well as to receive the magnetic field sensor signal and to determine an angle of rotation value based on the magnetic field sensor signal.

### BACKGROUND

Unless otherwise defined, the terms “axial”, “radial” and “transverse” as used below each refer to the shaft which is to be detected by the angle-of-rotation sensor system irrespective of whether the angle-of-rotation sensor system is mounted on the shaft or not. Unless otherwise specified, an axial direction is therefore understood to mean a direction extending parallel to the longitudinal axis of the shaft in the mounted state of the angle-of-rotation sensor system, a radial direction is understood to mean a direction extending perpendicular to the longitudinal axis of the shaft in the mounted state of the angle-of-rotation sensor system, and a transverse plane is understood to mean a plane extending transverse to the longitudinal axis of the shaft in the mounted state of the angle-of-rotation sensor system.

Angle-of-rotation sensor systems are also known as rotary encoders or rotary angle encoders. The Wiegand sensor unit and the magnetic field sensor unit in generic angle-of-rotation sensor systems are typically arranged at a small distance from each other, so that a significant interfering magnetic field is generated at the location of the magnetic field sensor unit due to a magnetization of the Wiegand wire of the Wiegand sensor unit that is always present during operation of the angle-of-rotation sensor system. This causes a systematic error in the magnetic field sensor signal provided by the magnetic field sensor unit and thus in the angle of rotation value determined based on the magnetic field sensor signal.

### SUMMARY

An aspect of the present invention is to provide a reliable and accurate angle-of-rotation sensor system for detecting the rotational movement of a shaft.

In an embodiment, the present invention provides a magnet-based angle-of-rotation sensor system for detecting a rotational movement of a shaft. The magnet-based angle-of-rotation sensor system includes an excitation unit comprising at least one excitation magnet, a Wiegand sensor unit comprising a sensor coil and at least one Wiegand wire which is arranged within the sensor coil, a magnetic field sensor unit, and an evaluation electronics. The excitation unit is configured to be mounted so as to rotate with the shaft and to generate an alternating excitation magnetic field at a location of the Wiegand sensor unit and at a location of the magnetic field sensor unit when the shaft rotates. The Wiegand sensor unit is configured so that Wiegand sensor voltage pulses are generated in the sensor coil by the alternating excitation magnetic field. The magnetic field sensor unit is configured to detect the alternating excitation magnetic field and to provide a magnetic field sensor signal corresponding thereto. The evaluation electronics is configured to detect the Wiegand sensor voltage pulses and to determine a number of revolutions based thereon, and to receive the magnetic field sensor signal and to determine an angle of rotation value based thereon. A first compensation parameter and a second compensation parameter are provided to the evaluation electronics. The evaluation electronics is further configured to alternately apply the first compensation parameter and the second compensation parameter to the magnetic field sensor signal received when determining the angle of rotation value.

### BRIEF DESCRIPTION OF THE DRAWINGS

The present invention is described in greater detail below on the basis of embodiments and of the drawings in which:

FIG. 1 schematically shows an angle-of-rotation sensor system for detecting a rotational movement of a shaft according to the present invention which is mounted on the shaft;

FIG. 2 schematically shows connections between components of the angle-of-rotation sensor system in an embodiment;

FIG. 3 schematically shows connections between the components of the angle-of-rotation sensor system in an alternative embodiment; and

FIG. 4 schematically shows temporal progressions of a magnetic field sensor signal, which is provided by a magnetic field sensor unit of the angle-of-rotation sensor system of FIGS. 1.

### DETAILED DESCRIPTION

The angle-of-rotation sensor system for detecting a rotational movement of a shaft according to the present invention comprises an excitation unit, a Wiegand sensor unit, a magnetic field sensor unit, and an evaluation electronics.

The excitation unit comprises at least one permanent-magnetic excitation magnet and is configured to be mounted so as to rotate with the shaft, the rotational movement of which is to be detected. The excitation unit is typically configured to be attached to the shaft, for example, to an end of the shaft. The at least one excitation magnet is configured and arranged so that when the shaft rotates, and consequently when the excitation unit rotates, an alternating excitation magnetic field, meaning an excitation magnetic field whose polarity continuously reverses, meaning that the (effective) direction of the field lines continuously changes over time, is generated at the location of the stationary Wiegand sensor unit and at the location of the stationary magnetic field sensor unit.

The Wiegand sensor unit comprises a sensor coil and at least one Wiegand wire which is arranged within the sensor coil. Wiegand wires within the meaning of the present application are also referred to as impulse wires and usually have a hard magnetic sheath and a soft magnetic core or vice versa. Under the influence of an external magnetic field, a direction of magnetization of the Wiegand wire abruptly inverts, whereby a short Wiegand sensor voltage pulse is generated in the sensor coil that radially surrounds the Wiegand wire, which Wiegand sensor voltage pulse is detectable via the two ends of the sensor coil. This effect is referred to as the “Wiegand effect” and is well known in the art. The Wiegand sensor unit typically comprises a single Wiegand wire, but may also have multiple Wiegand wires, all of which are arranged within the sensor coil. The Wiegand sensor unit, in particular the sensor coil and the at least one Wiegand wire, are configured and arranged so that when the shaft rotates, the alternating excitation magnetic field generated by the excitation unit at the location of the Wiegand sensor unit generates a sequence of Wiegand sensor voltage pulses in the sensor coil, typically one Wiegand sensor voltage pulse for each alternation of the excitation magnetic field.

The magnetic field sensor unit is configured to detect the alternating excitation magnetic field and provide a corresponding magnetic field sensor signal. The magnetic field sensor unit can, for example, comprise a TMR sensor, a GMR sensor, an AMR sensor, or a Hall sensor. The magnetic field sensor unit and the Wiegand sensor unit can, for example, be arranged on a common circuit board, wherein the magnetic field sensor unit and the Wiegand sensor unit are advantageously arranged opposite each other on opposite sides of the circuit board. The magnetic field sensor signal can, for example, be an analog signal the amplitude of which is proportional to a field strength or orientation of the detected excitation magnetic field, or can, for example, be a digital signal comprising a sequence of magnetic field sensor signal values each of which is proportional to a field strength or orientation of the detected excitation magnetic field. The magnetic field sensor signal typically comprises a sine component and a cosine component, wherein the sine component is proportional to a field strength of the detected excitation magnetic field with respect to a first spatial direction, and the cosine component is proportional to a field strength of the detected excitation magnetic field with respect to a second spatial direction that is perpendicular to the first spatial direction. The magnetic field sensor signal is typically provided via one or more electrical contacts. The magnetic field sensor signal can, however, in principle be provided in any way.

The evaluation electronics is electrically connected to the Wiegand sensor unit and is configured to detect the Wiegand sensor voltage pulses and to determine in a known manner a number of revolutions based thereon, in particular based on a number of detected Wiegand sensor voltage pulses and their polarity. The evaluation electronics is also configured to receive the magnetic field sensor signal from the magnetic field sensor unit and to determine an angle of rotation value based on the magnetic field sensor signal in a known manner. The evaluation electronics is typically electrically connected to the magnetic field sensor unit in order to transmit the magnetic field sensor signal. The evaluation electronics can, for example, be arranged on a common circuit board together with the magnetic field sensor unit and the Wiegand sensor unit. The evaluation electronics typically comprises at least one integrated circuit, in particular a so-called application-specific integrated circuit (ASIC) and/or a so-called “field programmable gate array” (FPGA) and/or a microcontroller. The evaluation electronics can, however, in principle be formed by any electrical circuit that is suitable for detecting the Wiegand sensor voltage pulses and determining the number of revolutions based thereon as well as for receiving the magnetic field sensor signal and determining the angle of rotation value based thereon.

When the shaft rotates, a direction of magnetization of the Wiegand wire of the Wiegand sensor unit changes continuously due to the alternating excitation magnetic field, resulting in a different effect of the disturbance magnetic field, which is generated by the magnetized Wiegand wire, on the magnetic field detected by the magnetic field sensor unit and thus on the magnetic field sensor signal provided by the magnetic field sensor unit, depending on the current direction of magnetization.

The present invention provides that a first compensation parameter and a second compensation parameter are provided to the evaluation electronics, and the evaluation electronics is configured to alternately apply the first compensation parameter and the second compensation parameter to the received magnetic field sensor signal when determining the angle of rotation value in order to compensate for the effects of the two different directions of magnetization of the Wiegand wire, which occur during operation, on the magnetic field sensor signal. This provides a reliable and accurate angle-of-rotation sensor system. The two compensation parameters can in principle be realized as a single compensation value or as a vector of several compensation values. The received magnetic field sensor signal typically has a sine component and a cosine component, wherein the sine component is proportional to a field strength of the detected excitation magnetic field relative to a first spatial direction, and the cosine component is proportional to a field strength of the detected excitation magnetic field relative to a second spatial direction that is perpendicular to the first spatial direction. It is in this case conceivable, for example, that the two compensation parameters each comprise an individual compensation value for the sine component and for the cosine component. It is also conceivable that one of the two compensation parameters is zero or a zero vector. The respective compensation parameter can, for example, be added to or subtracted from a current magnetic field sensor signal value when calculating with the magnetic field sensor signal. This provides for a particularly simple compensation. It is in principle also conceivable, however, that the respective compensation parameter is multiplied, divided or applied in a more complex manner to a current magnetic field sensor signal value when being applied to the magnetic field sensor signal. In any case, however, alternately, meaning in turns, either the first compensation parameter or the second compensation parameter is applied to the magnetic field sensor signal. The evaluation electronics can, for example, be configured to determine a current quadrant parameter based on the detected Wiegand sensor voltage pulses and/or the received magnetic field sensor signal, which quadrant parameter indicates in which 90° quadrant of the 360° full rotation the excitation unit that rotates with the shaft is currently located, and to decide based on the current quadrant parameter which of the two compensation parameters is applied to the magnetic field sensor signal.

The two compensation parameters can in principle be provided to the evaluation electronics in any suitable manner, for example, also via a data interface from an external system. However, the angle-of-rotation sensor system according to the present invention can, for example, comprise a (advantageously non-volatile) data storage in which the first compensation parameter and the second compensation parameter are stored and to which the evaluation electronics has at least read access. This makes it possible, for example, to determine the two compensation parameters once on a test bench and to then permanently store them in the data storage. The data storage can also be integrated, for example, as a so-called flash memory, together with the evaluation unit in an integrated circuit or a microcontroller. It is also conceivable, however, that the angle-of-rotation sensor system has a data interface via which the compensation parameters that are stored in the data storage can later be changed.

A Wiegand sensor voltage pulse is generally generated in the sensor coil each time the direction of magnetization of the Wiegand wire changes. The occurrence of a Wiegand sensor voltage pulse therefore indicates a change in the direction of magnetization of the Wiegand wire. The evaluation electronics can, for example, therefore be configured to change from applying the first compensation parameter to the received magnetic field sensor signal to applying the second compensation parameter to the received magnetic field sensor signal respectively from applying the second compensation parameter to the received magnetic field sensor signal to applying the first compensation parameter to the received magnetic field sensor signal upon detection of a Wiegand sensor voltage pulse. This enables a simple and yet relatively reliable determination of the points in time at which a change from one compensation parameter to the other should take place, for which no special device for detecting or monitoring the current direction of magnetization of the Wiegand wire are required.

As described above, the received magnetic field sensor signal typically has a sine component and a cosine component, wherein the sine component is proportional to the field strength of the detected excitation magnetic field with respect to the first spatial direction and the cosine component is proportional to the field strength of the detected excitation magnetic field with respect to the second spatial direction that is perpendicular to the first spatial direction. Since the Wiegand wire is usually arranged substantially parallel to one of these two spatial directions, either only the sine component of the magnetic field sensor signal or only the cosine component of the magnetic field sensor signal is typically significantly influenced by the interfering magnetic field generated by the Wiegand wire. In order to provide a particularly simple compensation of the influence of the interfering magnetic field, the evaluation electronics in this case can, for example, therefore be configured to apply the first compensation parameter or the second compensation parameter either only to the sine component or only to the cosine component.

The evaluation electronics can, for example, comprise an integrated circuit, for example, an ASIC, which is configured to detect the Wiegand sensor voltage pulses and to determine the number of revolutions based thereon, and a microcontroller which is configured to receive the magnetic field sensor signal, to determine the angle of rotation value based on the received magnetic field sensor signal, and to alternately apply the first compensation parameter and the second compensation parameter to the received magnetic field sensor signal when determining the angle of rotation value. The detection of the Wiegand sensor voltage pulses and the determination of the number of revolutions, which basically corresponds to incrementing or decrementing a count value when a Wiegand sensor voltage pulse occurs, can be realized particularly efficiently by an integrated circuit specially designed for this purpose, i.e., an ASIC. The integrated circuit is electrically connected to the Wiegand sensor unit in order to be able to detect the Wiegand sensor voltage pulses. The integrated circuit is typically also connected to a data storage in which at least a count value that reflects the number of revolutions is stored. The determination of the angle of rotation value based on the received magnetic field sensor signal using the two compensation parameters can be provided particularly efficiently by an appropriately programmed microcontroller.

The integrated circuit can, for example, be configured to provide a detection signal each time a Wiegand sensor voltage pulse is detected, and the microcontroller can, for example, be configured to receive the detection signal and, in response to the detection signal, to carry out a change from applying the first compensation parameter to the received magnetic field sensor signal to applying the second compensation parameter to the received magnetic field sensor signal respectively from applying the second compensation parameter to the received magnetic field sensor signal to applying the first compensation parameter to the received magnetic field sensor signal. This results in a particularly efficient angle-of-rotation sensor system.

An integrated circuit which is configured to detect the Wiegand sensor voltage pulses and to determine the number of revolutions based thereon is often already present. In order to avoid a generally relatively costly reconfiguration/redesign of the integrated circuit, in an alternative embodiment of the present invention, the microcontroller can, for example, therefore be electrically connected to the Wiegand sensor unit and configured to directly detect the Wiegand sensor voltage pulses and, upon detection of a Wiegand sensor voltage pulse, to carry out a change from applying the first compensation parameter to the received magnetic field sensor signal to applying the second compensation parameter to the received magnetic field sensor signal respectively from applying the second compensation parameter to the received magnetic field sensor signal to applying the first compensation parameter to the received magnetic field sensor signal.

An embodiment of the present invention is described below with reference to the attached drawings.

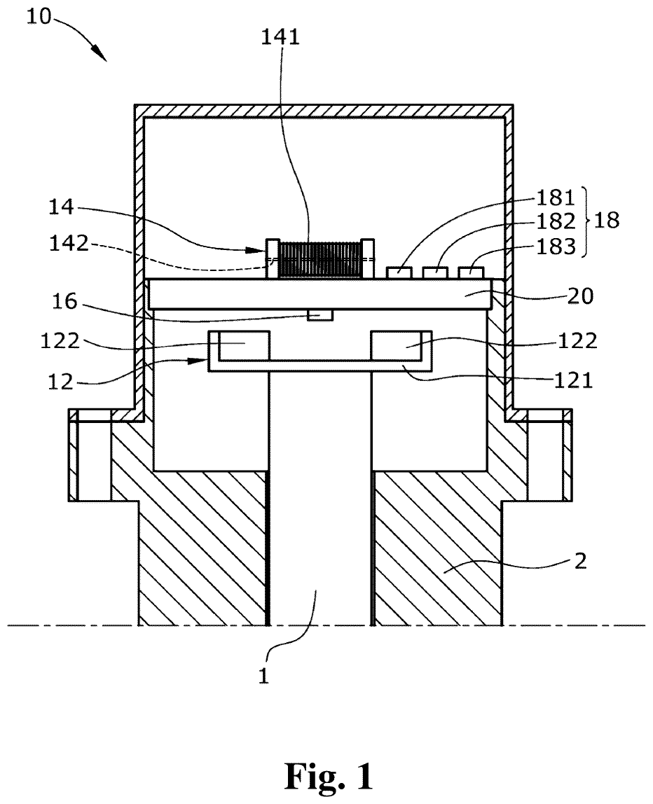

FIG. 1 shows an angle-of-rotation sensor system 10 which is arranged at an axial end of a shaft 1 to detect a rotational movement of the shaft 1. The angle-of-rotation sensor system 10 comprises an excitation unit 12 which is attached to the shaft 1. The angle-of-rotation sensor system 10 further comprises a Wiegand sensor unit 14, a magnetic field sensor unit 16, and an evaluation electronics 18, which are arranged on a circuit board 20 that is attached to a housing part 2.

The excitation unit 12 comprises a magnet carrier 121 which is attached to a front side of the shaft 1. The excitation unit 12 further comprises two permanent-magnetic excitation magnets 122 which are magnetized and which are arranged on the magnet carrier 121 so that an alternating excitation magnetic field is generated by the excitation magnets 122 both at the location of the Wiegand sensor unit 14 and at the location of the magnetic field sensor unit 16 when the shaft 1 rotates.

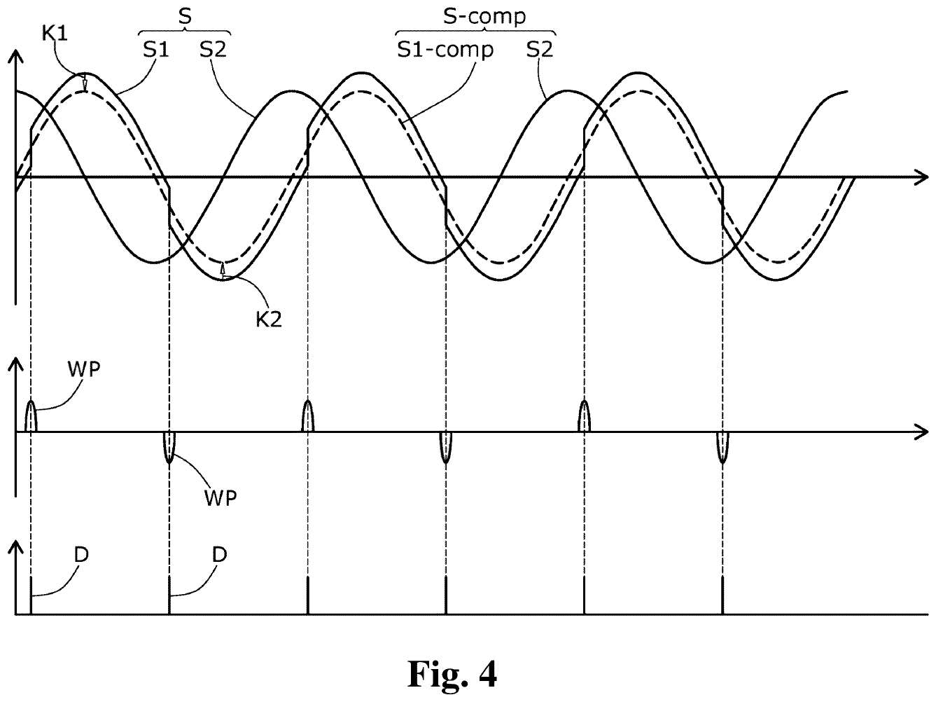

The Wiegand sensor unit 14 is arranged on an axial side of the circuit board 20, which is remote from the shaft 1, and comprises a sensor coil 141 as well as a Wiegand wire 142, which is arranged within the sensor coil 141. The sensor coil 141 and the Wiegand wire 142 are configured and arranged so that a sequence of Wiegand sensor voltage pulses WP is generated in the sensor coil 141 by the alternating excitation magnetic field, which is generated by the excitation magnets 122 when the shaft 1 rotates, as shown schematically in FIG. 4, wherein the Wiegand sensor voltage pulses WP can be detected via the two ends of the sensor coil 141.

The magnetic field sensor unit 16 is arranged opposite the Wiegand sensor unit 14 on an axial side of the circuit board 20 that faces towards the shaft 1. The magnetic field sensor unit 16 is configured to detect the alternating excitation magnetic field and, as shown schematically in FIG. 4, to provide a corresponding magnetic field sensor signal S with a sine component S1 and a cosine component S2 at electrical contacts that are intended for this purpose. In the present embodiment, the sine component S1 is proportional to a field strength of the detected excitation magnetic field with respect to a spatial direction that is parallel to a longitudinal axis of the Wiegand wire 142, and the cosine component S2 is proportional to a field strength of the detected excitation magnetic field with respect to a spatial direction that is perpendicular to the longitudinal axis of the Wiegand wire 142.

The evaluation electronics 18 comprises an integrated circuit 181, a microcontroller 182, and a data storage 183.

The integrated circuit 181 is electrically connected to the Wiegand sensor unit 14 and is configured to detect the Wiegand sensor voltage pulses WP that are generated in the sensor coil 141. The integrated circuit 181 is further configured to determine a number of revolutions N based on a number and a polarity of the detected Wiegand sensor voltage pulses WP and to store the same in the data storage 183.

The microcontroller 182 is electrically connected to the electrical contacts of the magnetic field sensor unit 16, which are intended for providing the magnetic field sensor signal S, and is configured to receive the magnetic field sensor signal S. The microcontroller 182 is further configured to read from the data storage 183 a first compensation parameter K1 which is stored in the data storage 183 and a second compensation parameter K2 which is stored in the data storage 183. The microcontroller 182 is further configured to alternately apply the first compensation parameter K1 and the second compensation parameter K2 to the magnetic field sensor signal S, as shown schematically in FIG. 4, in order to determine a compensated magnetic field sensor signal S-comp. Specifically, the microcontroller 182 is configured to alternately add the first compensation parameter K1 and the second compensation parameter K2 to the sine component S1 of the magnetic field sensor signal S in order to determine a compensated sine component S1-comp, which together with the cosine component S2 constitutes the compensated magnetic field sensor signal S-comp. The microcontroller 182 is further configured to determine an angle of rotation value A based on the compensated magnetic field sensor signal S-comp and to store the same in the data storage 183.

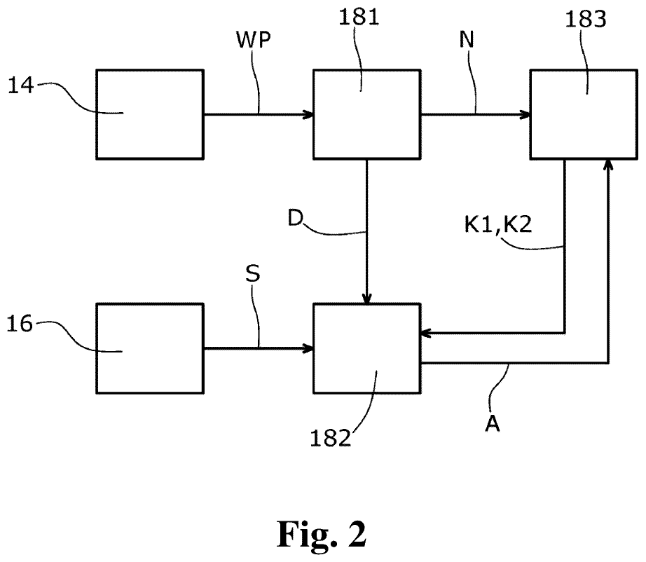

In an embodiment of the angle-of-rotation sensor system 10 that is schematically shown in FIG. 2, the integrated circuit 181 is configured, as shown schematically in FIG. 4, to provide a detection signal D at an electrical contact, which is intended for this purpose, each time a Wiegand sensor voltage pulse WP is detected. In this embodiment, the microcontroller 182 is electrically connected to the respective electrical contact of the integrated circuit 181 and configured to receive the detection signal D. The microcontroller 182 is also configured in this case to change from adding the first compensation parameter K1 to the sine component S1 to adding the second compensation parameter K2 to the sine component S1 or vice versa each time in response to receiving the detection signal D, i.e., to change from applying the first compensation parameter K1 to the magnetic field sensor signal S to applying the second compensation parameter K2 to the magnetic field sensor signal S or vice versa each time.

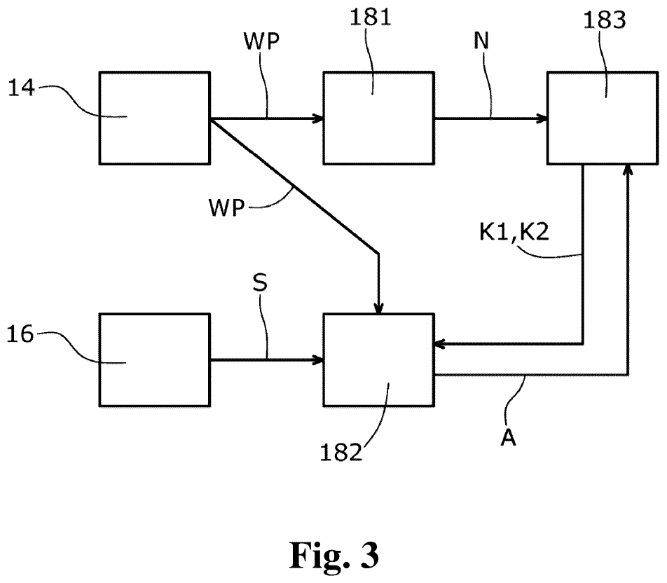

In an alternative embodiment of the angle-of-rotation sensor system 10 that is schematically shown in FIG. 3, the microcontroller 182 is electrically connected to the Wiegand sensor unit 14 and is configured to detect the Wiegand sensor voltage pulses WP generated in the sensor coil 141. The microcontroller 182 is also configured in this case to change from adding the first compensation parameter K1 to the sine component S1 to adding the second compensation parameter K2 to the sine component S1 or vice versa each time a Wiegand sensor voltage pulse WP is detected, i.e., to change from applying the first compensation parameter K1 to the magnetic field sensor signal S to applying the second compensation parameter K2 to the magnetic field sensor signal S or vice versa each time.

FIG. 4 schematically shows the temporal progressions of a magnetic field sensor signal, which is provided by a magnetic field sensor unit of the angle-of-rotation sensor system of FIG. 1, of a compensated magnetic field sensor signal, which is obtained by applying compensation parameters to the magnetic field sensor signal, of Wiegand sensor voltage pulses, which are generated in a Wiegand sensor unit of the angle-of-rotation sensor system of FIG. 1, and of a detection signal, which is provided by an integrated circuit of the angle-of-rotation sensor system of FIG. 1.

The present invention is not limited to embodiments described herein; reference should be had to the appended claims.

### List of Reference Characters

| | |
|---|---|
| 1 | shaft |
| 2 | housing part |
| 10 | angle-of-rotation sensor system |
| 12 | excitation unit |
| 121 | magnet carrier |
| 122 | excitation magnets |
| 14 | Wiegand sensor unit |
| 141 | sensor coil |
| 142 | Wiegand wire |
| 16 | magnetic field sensor unit |
| 18 | evaluation electronics |
| 181 | integrated circuit |
| 182 | microcontroller |
| 183 | data storage |
| 20 | circuit board |
| A | angle of rotation value |
| D | detection signal |
| K1 | first compensation parameter |
| K2 | second compensation parameter |
| N | number of revolutions |
| S | magnetic field sensor signal |
| S1 | sine component |
| S2 | cosine component |
| S-comp | compensated magnetic field sensor signal |
| S1-comp | compensated sine component |
| WP | Wiegand sensor voltage pulse(s) |

1-7. (canceled)

8. A magnet-based angle-of-rotation sensor system for detecting a rotational movement of a shaft, the magnet-based angle-of-rotation sensor system comprising:
an excitation unit comprising at least one excitation magnet;
a Wiegand sensor unit comprising a sensor coil and at least one Wiegand wire which is arranged within the sensor coil;
a magnetic field sensor unit; and
an evaluation electronics,
wherein,
the excitation unit is configured to be mounted so as to rotate with the shaft and to generate an alternating excitation magnetic field at a location of the Wiegand sensor unit and at a location of the magnetic field sensor unit when the shaft rotates,
the Wiegand sensor unit is configured so that Wiegand sensor voltage pulses are generated in the sensor coil by the alternating excitation magnetic field,
the magnetic field sensor unit is configured to detect the alternating excitation magnetic field and to provide a magnetic field sensor signal corresponding thereto,
the evaluation electronics is configured to detect the Wiegand sensor voltage pulses and to determine a number of revolutions based thereon, and to receive the magnetic field sensor signal and to determine an angle of rotation value based thereon,
a first compensation parameter and a second compensation parameter are provided to the evaluation electronics, and
the evaluation electronics is further configured to alternately apply the first compensation parameter and the second compensation parameter to the magnetic field sensor signal received when determining the angle of rotation value.

9. The magnet-based angle-of-rotation sensor system as recited in claim 8, further comprising:
a data storage in which the first compensation parameter and the second compensation parameter are stored and to which the evaluation electronics is further configured to have access.

10. The magnet-based angle-of-rotation sensor system as recited in claim 8, wherein the evaluation electronics, upon detection of one of the Wiegand sensor voltage pulses, is configured to alternate the applying of the first compensation parameter to the magnetic field sensor signal received to applying the second compensation parameter to the magnetic field sensor signal received, or to alternate the applying of the second compensation parameter to the magnetic field sensor signal received to applying the first compensation parameter to the magnetic field sensor signal received, as the case might be.

11. The magnet-based angle-of-rotation sensor system as recited in claim 8, wherein,
the magnetic field sensor signal received has a sine component and a cosine component, and
the evaluation electronics is further configured to apply the first compensation parameter respectively the second compensation parameter only to the sine component or only to the cosine component.

12. The magnet-based angle-of-rotation sensor system as recited in claim 8, wherein the evaluation electronics comprises:
an integrated circuit which is configured to detect the Wiegand sensor voltage pulses and to determine the number of revolutions based thereon; and
a microcontroller which is configured to receive the magnetic field sensor signal, to determine the angle of rotation value based on the magnetic field sensor signal received, and to alternately apply the first compensation parameter and the second compensation parameter to the magnetic field sensor signal received when determining the angle of rotation value.

13. The magnet-based angle-of-rotation sensor system as recited in claim 12, wherein,
the integrated circuit is further configured to provide a detection signal each time one of the Wiegand sensor voltage pulses is detected, and
the microcontroller is further configured to receive the detection signal and, in response to the detection signal, to alternate the applying of the first compensation parameter to the magnetic field sensor signal received to applying the second compensation parameter to the magnetic field sensor signal received, or to alternate the applying the second compensation parameter to the magnetic field sensor signal received to applying the first compensation parameter to the magnetic field sensor signal received, as the case might be.

14. The magnet-based angle-of-rotation sensor system as recited in claim 12, wherein the microcontroller is further configured to detect the Wiegand sensor voltage pulses and, upon detection of one of the Wiegand sensor voltage pulses, to alternate the applying of the first compensation parameter to the magnetic field sensor signal received to applying the second compensation parameter to the magnetic field sensor signal received, or to alternate the applying of the second compensation parameter to the magnetic field sensor signal received to applying the first compensation parameter to the magnetic field sensor signal received, as the case might be.
